(19) United States
(12) Patent Application Publication
(10) Pub. No.: US 2017/0339336 A1
(43) Pub. Date: Nov. 23, 2017

(54) Graphical User Interface for a Video Surveillance System

(71) Applicant: Verint Americas Inc., Alpharetta, GA (US)

(72) Inventor: Shahar Daliyot, Ramot Meir (IL)

(21) Appl. No.: 15/160,408

(22) Filed: May 20, 2016

(51) Int. Cl. H04N 5/232; G06F 3/0484; G06F 3/0481; G06F 3/0486; H04N 7/18; H04N 5/77

(52) U.S. Cl. CPC H04N 5/23216; H04N 7/181; H04N 5/77; H04N 5/23296; G06F 3/04817; G06F 3/0486; G06F 3/04847; H04N 5/23206

(57) ABSTRACT

A graphical user interface (GUI) for video management software controlling a video surveillance system typically provides a user with a large range of viewing options. A user must interact with a variety of GUI controls to view video in a particular way. These interactions are time consuming and may be aggravating to a user, especially when the user routinely views video in a particular way. The present disclosure embraces a GUI in which camera icons may be dragged and/or dragged-and-dropped in drop areas to execute scripts enabling various viewing and camera-control operations.

### FIELD OF THE INVENTION

The present disclosure relates to software graphical user interfaces, and more specifically, to a graphical user-interface (GUI) for video management software (VMS), which has drag-and-drop functionality for controlling video.

### BACKGROUND

A video surveillance system includes video management software through which a user can interact with a network of cameras and/or stored recordings. The video management software (VMS) typically provides a graphical user interface (GUI) to facilitate the interaction. The GUI may supply basic viewing control, such as viewing live video from a camera or viewing video from a recording. In addition, the GUI may supply advanced viewing control, such as fast-forward/reverse playback, viewing at different speeds, viewing a snippet from a recording, and/or viewing size. Further, the GUI may supply camera control, such as moving a camera to specific pan-tilt-zoom (PTZ) position (e.g., a particular direction), allowing a user to view video from a particular region.

The GUI controls are typically generalized to provide a user with a large range of potential control/viewing options. The range of control/viewing options increases further as the size of the camera network and the number of stored recordings increase. As result, a user must interact with a variety of GUI controls to view video in a particular way. For example, a user may have select a drop down, answer a dialog, and click on an option to view video in a particular way. These interactions are time consuming and may be aggravating to a user, especially when the user routinely views video in a particular way.

Therefore, a need exists for convenient means for controlling the video viewed from a video surveillance system.

### SUMMARY

Accordingly, in one aspect, the present disclosure embraces a method for controlling video from a video surveillance system. The method includes the step of providing a graphical user interface (GUI). The GUI includes camera icons representing cameras in the video surveillance system, wherein each camera icon supports drag-and-drop interactions. The GUI also includes tiles for displaying video from a camera or a recorder. In addition, the GUI includes at least one drop area positioned on a tile. The (at least one) drop areas enable scripts, which control the viewing of video. The method also includes the step of executing a script when a camera icon is dragged into a particular drop area.

In an exemplary embodiment, the executing a script occurs after the camera icon is dragged and then dropped onto the drop area (i.e., as opposed to dragged into the drop area without dropping).

In another exemplary embodiment of the method, the drop areas are semi-transparent icons that contain graphics and/or text to indicate the drop area's function (i.e., the drop area's corresponding script or scripts). The semi-transparent icons are positioned over one or more of the tiles.

In another exemplary embodiment of the method, the drop area's script depends on the particular camera dragged onto the drop area (i.e., a drop area's function changes depending on which camera is dragged onto the drop area). For example, a drop area may spawn one or more new drop areas in response to a particular camera icon being dragged into the particular drop area. The spawned drop areas may correspond to configurable parameters for the script. The configurable parameters may include camera settings (e.g., camera direction) or video playback settings. For example, a spawned drop area may control functions suited for a particular camera but not necessarily suited for each camera in the camera network.

The drop area scripts may execute various operations. In other exemplary embodiments of the method, the operations include (but are not limited to) setting a pan, tilt, and/or zoom settings for a camera, setting the direction (e.g., forward, reverse) in which the video is viewed, setting a video viewing speed, setting a viewing zoom level, and/or setting a start time and a stop time for viewing a snippet of a video recorded from a camera.

In another exemplary embodiment of the method, the drop areas and the scripts are user-configurable, while in still another exemplary embodiment the drop areas and the scripts are factory-set and not user-configurable.

In another aspect, the present disclosure embraces a computer readable medium containing computer readable instructions that when executed by a processor of a computer cause the computer to execute the method described above.

In another aspect, the present disclosure embraces a video surveillance system. The video surveillance system includes a network of video cameras and a recorder that is communicatively coupled to the network of video cameras. The video surveillance system also includes a computer with a display screen that is communicatively coupled to the video cameras and the recorder. The computer is configured to execute video management software (VMS) to generate and render a graphical user interface (GUI) on the display screen. The GUI is operable to display camera icons that represent video cameras in the network of video cameras, tiles for displaying video, and at least one drop area positioned on a tile that enable scripts to control the viewing of video. The GUI is operable to execute a particular script in response to signals from the computer's input device, which correspond to a particular camera icon being dragged into a particular drop area.

In an exemplary embodiment of the video surveillance system, the particular script is executed in response to a particular camera icon being (i) dragged into a particular drop area and (ii) dropped onto a the particular drop area.

In another exemplary embodiment of the video surveillance system, the executed script spawns one or more new drop areas in response to the particular camera icon being dragged into the particular drop area.

In another exemplary embodiment of the video surveillance system, the particular script controls how a video is played in the video tile.

In another exemplary embodiment of the video surveillance system, the particular script controls a video camera in the video surveillance system.

In another exemplary embodiment of the video surveillance system, the particular script controls the recorder.

The foregoing illustrative summary, as well as other exemplary objectives and/or advantages of the disclosure, and the manner in which the same are accomplished, are further explained within the following detailed description and its accompanying drawings.

Other systems, methods, features, and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

FIG. 1 schematically depicts a video surveillance system according to an exemplary embodiment of the present disclosure.

FIG. 2 graphically depicts a computer according to an exemplary embodiment of the present disclosure.

FIG. 3 graphically depicts a graphical user interface (GUI) for a video management system used for a video surveillance system according to an embodiment of the present disclosure.

FIG. 4 graphically depicts the GUI of FIG. 3 with a tile containing two drop areas for viewing video and a camera dragged into a drop area according to an embodiment of the present disclosure.

FIG. 5 graphically depicts the GUI of FIG. 3 with a tile containing three drop areas arranged, colored, marked, and sized differently according to an embodiment of the present disclosure.

FIG. 6 graphically depicts the GUI of FIG. 3 with a tile containing semi-transparent drop areas (including spawned drop areas—North”, “South”, “East”, and “West”) positioned over a video according to an embodiment of the present disclosure.

FIG. 7 depicts a flow chart of an exemplary method for controlling video from a video surveillance system according to an embodiment of the present disclosure.

### DETAILED DESCRIPTION

The present disclosure embraces a surveillance system having video management software (VMS) with a convenient drag-and-drop interaction for selecting and viewing video.

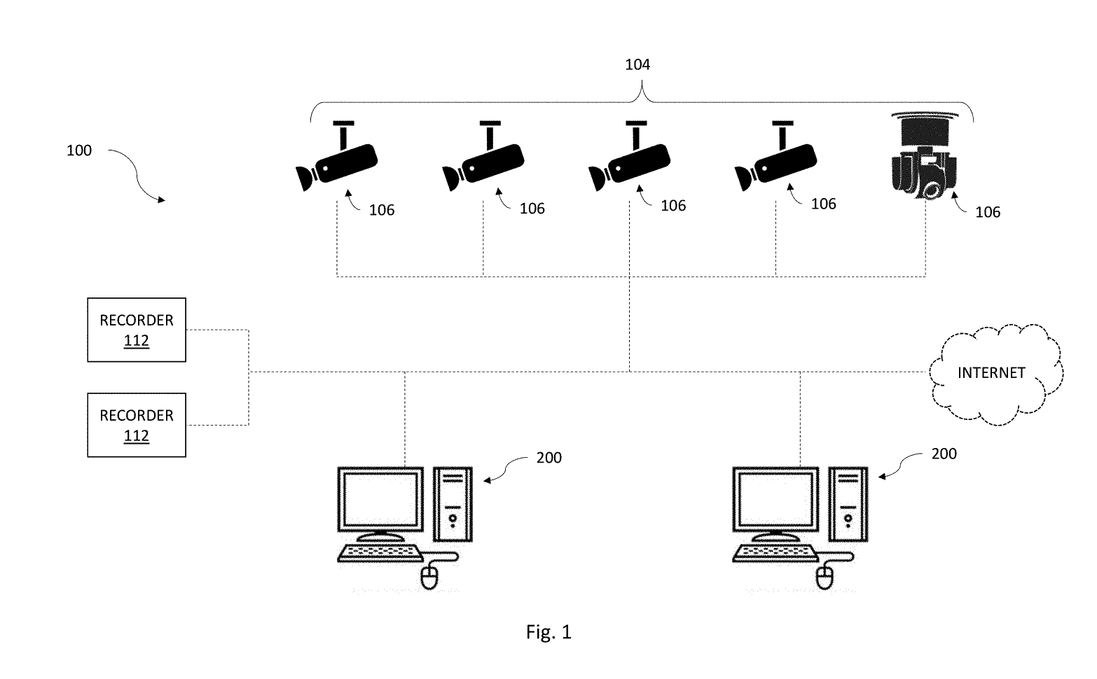

An exemplary surveillance system is shown in FIG. 1. The system includes a network of cameras 104 (i.e., video cameras) that communicate to one or more computers 200 and, in some embodiments, to one or more recorders 112. Each camera may transmit video in analog format (e.g., NTSC, PAL, RGB, etc.) or digital format (e.g., MPEG, H.264, JPEG video, etc.). The digital formatted video may be communicated over a communication medium (e.g., as coax, wireline, optical fiber, wireless), or a combination of communication media, using a communication protocol (e.g., TCP/IP).

The cameras 106 in the network are typically installed in fixed locations around a monitored area (e.g., airport, office, warehouse, store, parking lot, etc.). In some embodiments, a camera may be remotely controlled by a computer 200. The control signals can facilitate a change in the camera's settings (e.g. focus, illumination, zoom, etc.) and/or the camera's position (e.g., by panning and/or tilting).

The system 100 may include one or more recorders 112 that are connected to the cameras 106. A recorder may be analog but typically, a digital video recorder (DVR) is used. In one possible embodiment, a recorder 112 is located at a site that is located away from the site (i.e., facility) in which the camera network is installed. In this case, the recorder site may communicate with the camera network site via the internet. In another possible embodiment, a recorder 112 may be integrated with a 200 computer. The recorder 112 may be configured to record live streaming video from one or more cameras 106 and may also be configured to play back recorded video on a computer's display 212.

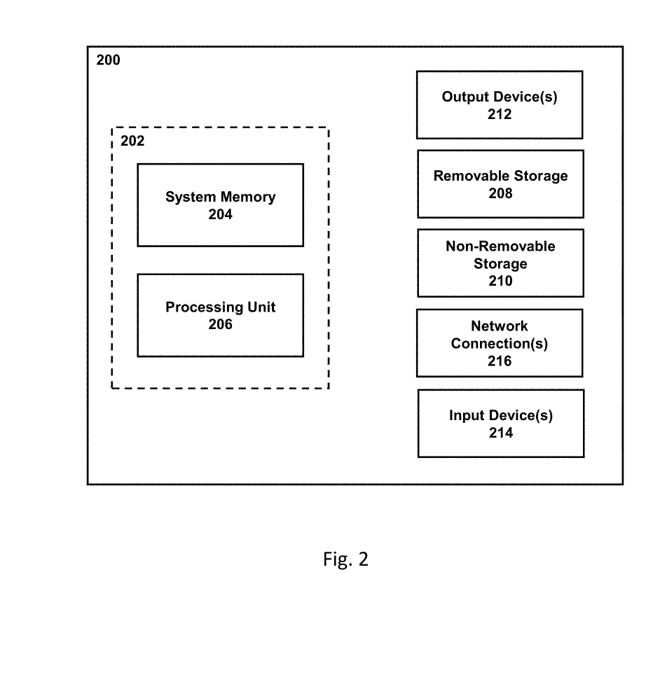

The logical operations described herein with respect to the various figures may be implemented (i) as a sequence of computer implemented acts or program modules (i.e., software) running on a computer (e.g., the computer described in FIG. 2), (ii) as interconnected machine logic circuits or circuit modules (i.e., hardware) within the computer and/or (iii) as a combination of software and hardware of the computer. Thus, the logical operations discussed herein are not limited to any specific combination of hardware and software. The implementation is a matter of choice dependent on the performance and other requirements of the computer. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 2, an example computer 200 upon which embodiments of the disclosure may be implemented is illustrated. It should be understood that the example computer 200 is only one example of a suitable computing environment upon which embodiments of the disclosure may be implemented. Optionally, the computer 200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computers, which are connected to a communication network or other data transmission medium, to perform various tasks. In the distributed computing environment, the program modules, applications, and other data may be stored on local and/or remote computer storage media.

In its most basic configuration, a computer 200 typically includes at least one processing unit 206 and system memory 204. Depending on the exact configuration and type of computer, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the computer 200. The computer 200 may also include a bus or other communication mechanism for communicating information among various components of the computer 200.

Computer 200 may have additional features and/or functionality. For example, computer 200 may include additional storage such as removable storage 208 and non-removable storage 210 including, but not limited to, magnetic or optical disks or tapes. A Computer 200 may also contain network connection(s) 216 that allow the device to communicate with other devices. Computer 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computer 200. All these devices are well known in the art and need not be discussed at length here.

The processing unit 206 may be configured to execute program code encoded in tangible, computer-readable media. Tangible, computer-readable media refers to any media that is capable of providing data that causes the computer 200 (i.e., a machine) to operate in a particular fashion. Various computer-readable media may be utilized to provide instructions to the processing unit 206 for execution. Example tangible, computer-readable media may include, but is not limited to, volatile media, non-volatile media, removable media, and non-removable media implemented in any method or technology for storage of information such as computer readable instructions, data structures, program modules or other data. System memory 204, removable storage 208, and non-removable storage 210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computer generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

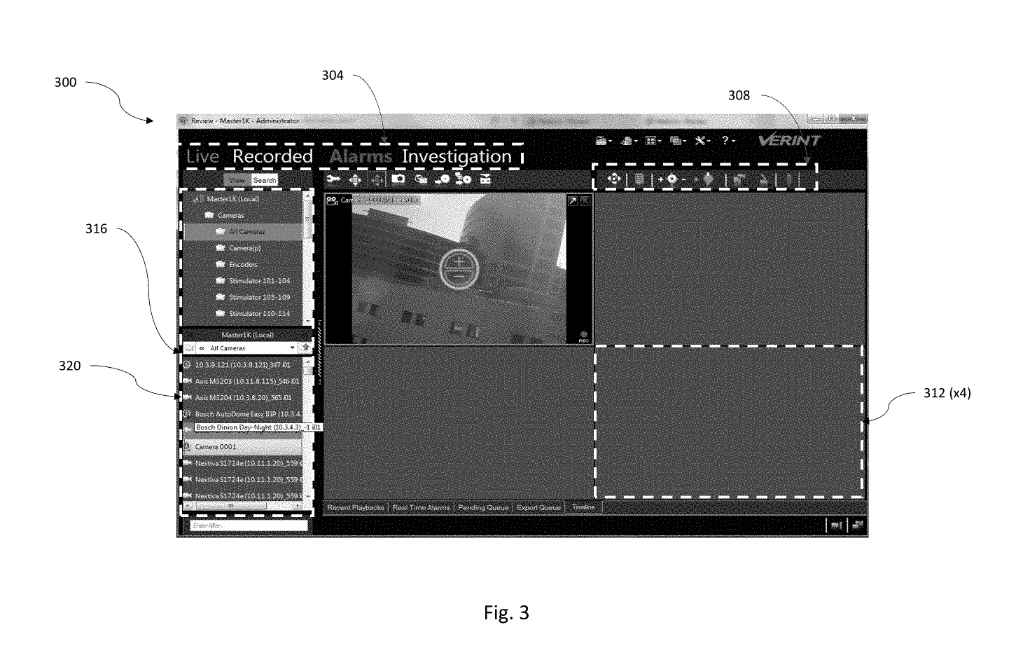

The video surveillance system may execute video management software (VMS) running on a computer 200. The VMS allows an operator to interact with the cameras 106 and the recorders 112. The interaction is enabled by a GUI that is part of the VMS. An exemplary GUI 300 is shown in FIG. 3. A navigation toolbar 304 allows a user to select various modes of operation. The modes include (but are not limited to) “live” for viewing live video from a selected camera, “recorded” for viewing video from a selected camera recorded on a recorder, “alarms” for working with alarms associated with the video, and “investigation” for analyzing video.

The GUI, as shown in FIG. 3, also includes a workspace toolbar 308 that allows access to video controls and display features, such as pan/tilt/zoom (PTZ) controls for a PTZ camera (e.g., see FIG. 1, right most camera 106).

The GUI workspace is divided into video tiles (i.e., tiles) 312. The workplace shown in FIG. 3 has four tiles, one of which (i.e., upper left) displays video from a camera. The video tiles allow for viewing live and recorded video but may also display images. The workspace may hold a plurality of video tiles (e.g., up to 64 tiles). The number and configuration of the video tiles may be controlled by a user in possible embodiments.

The GUI may also include panes. The GUI shown in FIG. 3 includes a navigation pane 316 that displays icons (e.g., folders, cameras, tours, maps, monitors, bookmarks, alarms, investigation attachments, etc.) to select and control components of the surveillance system.

The video management system (VMS) facilitates the query and review video from various cameras. A user can interact with the GUI to view live video from a camera or recorded video (e.g., from a specific time-range) from a recorder. In addition, there are more advanced video viewing options including (but not limited to), fast-forward, rewind (e.g. at speeds of 1×, 2×, 4×, etc.), view in full-screen mode, and move to specific preset camera position. The viewing options may be activated through multiple clicks, dialogs, and context-menus. For example, to play the last 5 minutes of a specific camera's video, in 4×-fast-forward, and on a specific tile, a user typically must perform several interactions. A user must first switch to recorded mode, then drag the camera icon to a tile, then select the required time-range in a video query dialog, and finally switch to 4×-fast-forward play once the video starts. The present disclosure embraces replacing all of these interactions with a drag-drop action.

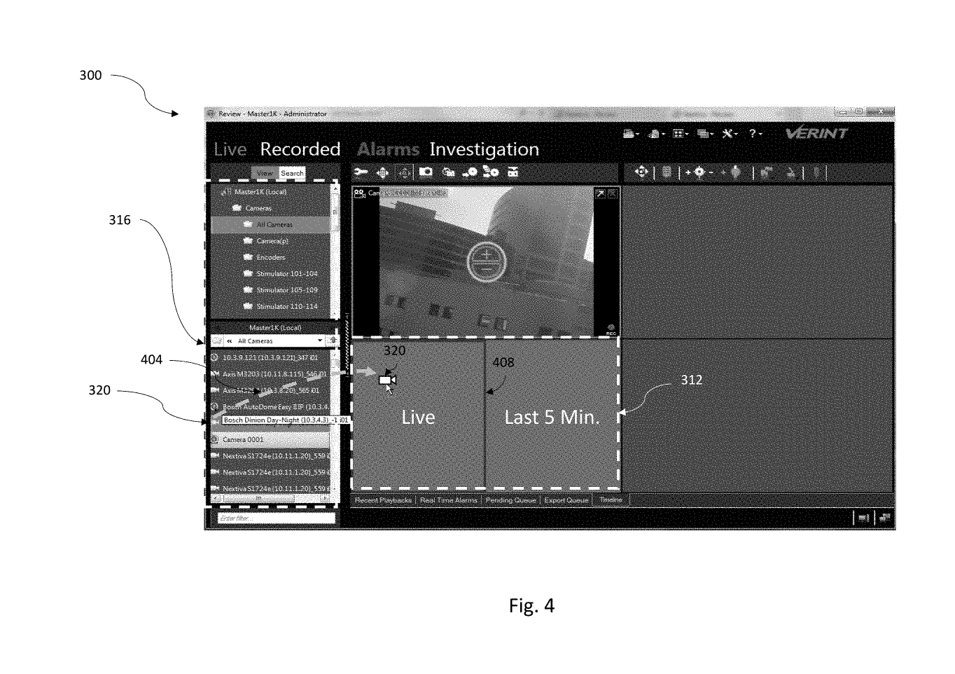

In an exemplary implementation shown in FIG. 4, a camera icon 320 from the navigation pane 316 may be dragged 404 into a drop area 408 situated on top and within the borders of a tile 312. A video corresponding to the camera represented by the camera icon (i.e., either recorded or live video) may then be played in a particular way corresponding the drop area. The video may be played in any tile including the tile in which the drop area is located.

A script, for viewing video in a particular way, is executed when a user drags 404 the camera icon 320 into the drop area 408. Alternatively, the script representing viewing options may be executed when a user drags and then drops (i.e., drag-and-drop) the camera icon 320 into the drop area 408. It is also possible for a camera icon to be positioned over a drop area but not dropped (i.e., “hovered”). The drop area may change when a camera is hovered over the drop area. For example, the hovered-over drop area may be highlighted by a border on its edges, as shown in FIG. 4.

Drop areas are icons (e.g., image, button, tile, etc.) that may be displayed differently (e.g., via size, shape, color, transparency, etc.) to differentiate one drop area from another. Further, a drop area may contain indicia (e.g., icons, graphics) and/or text to indicate the purpose of the drop area. The drop areas may be always visible in the GUI or may appear and disappear as selected/highlighted in the GUI.

Multiple drop areas may be contained within a tile 312. The drop areas may be factory set, user-created, user-customized, and/or auto-generated. For example, a drop area may be auto-generated based on a user's interaction with the GUI over time (e.g., a user's most common queries, most common operations, etc.). Different tiles in the GUI may contain the same or different drop areas.

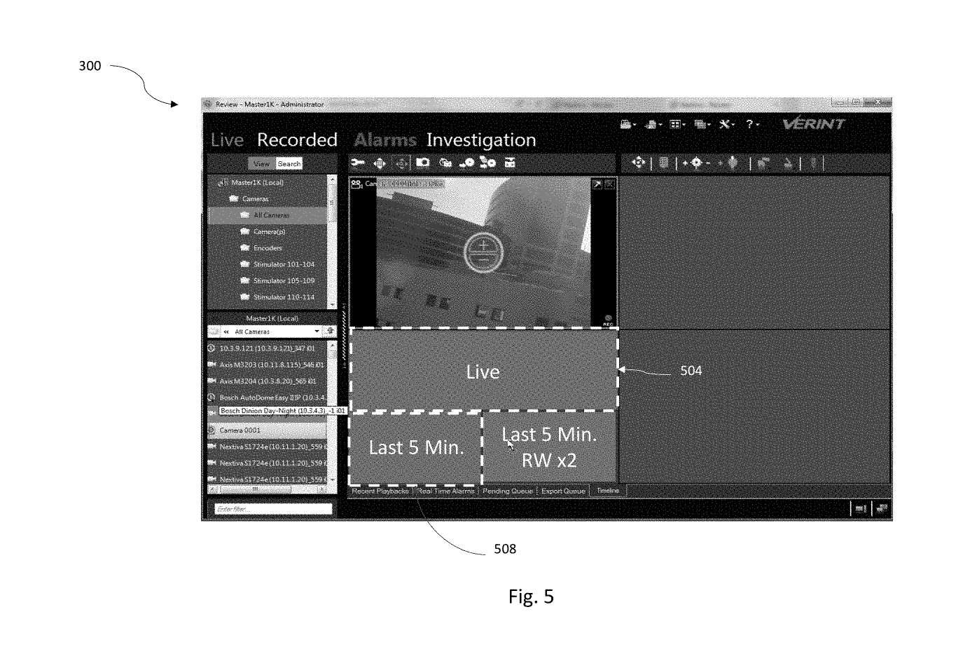

The color/shape/size/position of drop areas and/or indicia (e.g., graphics) on drop areas may be fixed or dynamic (e.g., customizable, depend on mode, etc.). For example, the size/position of a drop area may be based on based on user's most commonly performed operation. In one example, the most common operation may be assigned a larger drop area, while a less common operation may be assigned a smaller drop area. As shown in FIG. 5, a drop area representing a script to control the viewing of video live video 504 is larger than a drop area representing a script to control the viewing of the last 5 minutes of video 508.

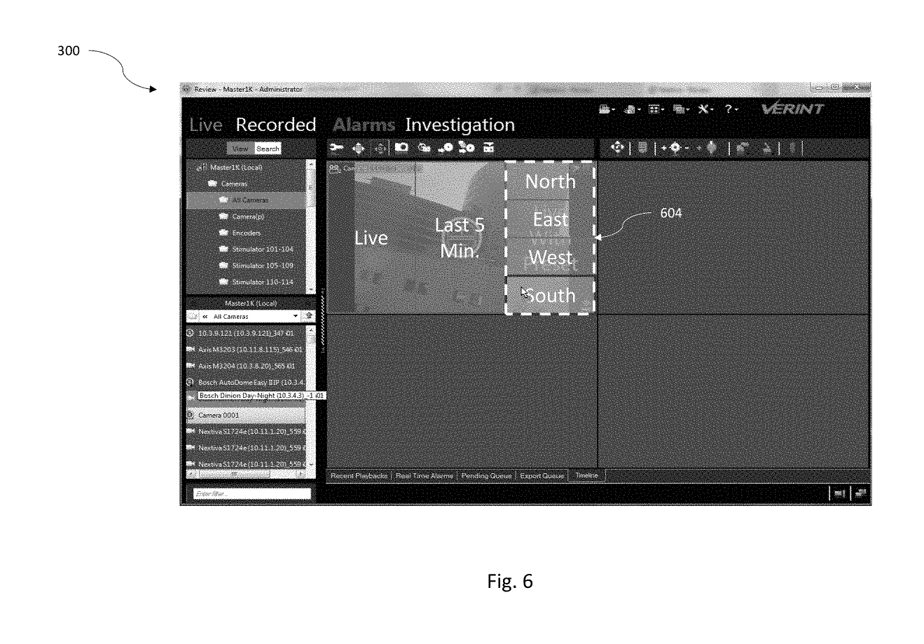

Drop areas may be opaque or semi-transparent. As shown in FIG. 6, drop areas 604 may be superimposed on a tile displaying an image or video. Semi-transparent drop areas allow the image or video underneath to still be observed.

Drop areas may also spawn other drop areas (e.g., subdivide) upon a GUI interaction (e.g., a camera icon is hovered over a drop area). For example, a drop area may represent a script to query the last few minutes of recorded video from a video camera (i.e., camera). When a camera icon is dragged into (i.e., on top of) the drop area, the drop area may spawn other drop areas, representing different time ranges for the query (e.g., 1 min., 2 min., 3 min., 5 min, etc.). The camera may then be dragged into one of the spawned drop areas and dropped to execute the script with the particular time range.

Drop areas may also control camera settings. A pan-tilt-zoom (PTZ) camera, for example, may be controlled to view a particular area. A camera icon representing the PTZ camera may be dragged into a drop area to execute a script that sends the PTZ camera to a particular position/zoom-level (e.g., a selected preset location). This interaction may use spawned drop areas. As shown in FIG. 6, when a PZT camera icon is hovered over a drop area for adjusting camera view (e.g., view live at preset), the drop area may split into or spawn drop areas representing preset directions of the camera (e.g., north, south, east, west, etc.) 604.

The scripts represented by drop areas may change depending on the GUI settings (e.g., live mode or recorded mode). The scripts represented by drop areas may also depend on the camera icon dragged into the drop area. For example, a PZT camera icon dragged into a drop area may spawn direction controlling drop areas 604, whereas a fixed mount camera dragged into the same drop area may not spawn direction controlling drop areas.

A list of video viewing options that may be controlled by scripts activated by drop areas include (but are not limited to):
video quality (e.g., resolution, interlacing. etc.),
playback audio volume (e.g., mute, etc.),
playback direction (e.g., forward, backward),
playback speed (e.g., 2×, etc.),
step playback,
playback length (e.g., last 5 minutes),
playback start/stop times,
looping playback,
quick jump forward/backward,
scan for activity in video,
alarms,
video tours (i.e., sequence of views from one or more cameras at a cycle rate),
camera control (e.g., position, focus, iris, illumination, zoom, scan, etc.), and
zoom (e.g., digital zoom).

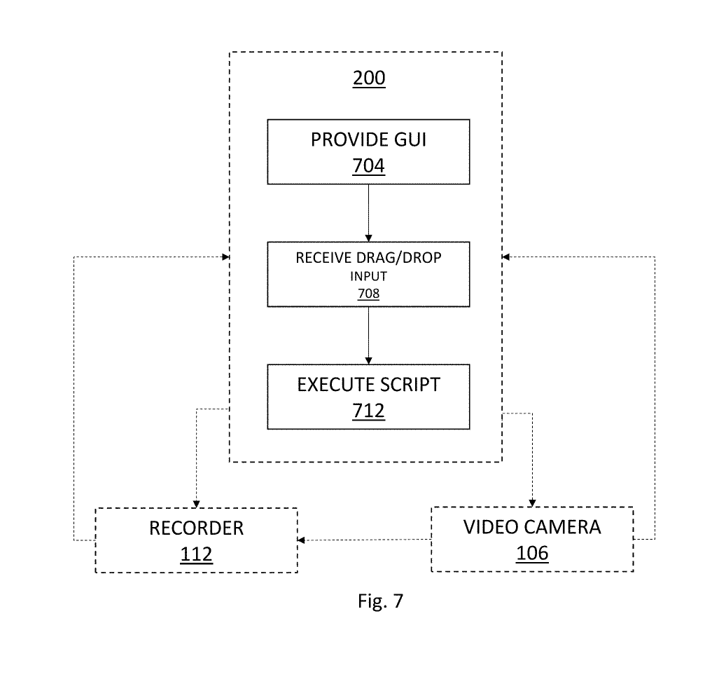

A flow chart depicting an exemplary method for controlling video from a video surveillance system is shown in FIG. 7. A graphical user interface (GUI) is provided 704. The GUI is typically created by VMS running on the computer 200 and displayed on the computer's display. The GUI includes camera icons representing cameras in the video surveillance system, each supporting drag-and-drop interactions. For example, a user may control an input device (e.g., mouse) attached to the computer to select (i.e., click on), drag (i.e., move), and drop (i.e., release) camera icons to different areas on the GUI. The GUI includes tiles for displaying video from a camera (i.e., live video) or a recorder (i.e., recorded video). The tiles may contain drop areas that enable scripts to control the viewing of video corresponding to the camera dragged (and in some cases dropped) in the drop area. The GUI receives a drag/drop input (i.e., signals from a user input device) 708, wherein a camera is dragged in, dropped in, or hovered over a drop area. In response to the input, a script controlling the viewing of video and/or the control of one or more cameras/recorders is executed 712.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

1. A method for controlling video from a video surveillance system, the method comprising:
providing a graphical user interface (GUI) that includes:
camera icons representing cameras in the video surveillance system, wherein the camera icons support drag-and-drop interactions,
tiles for displaying video from a camera or a recorder, and
at least one drop area positioned on a tile, wherein the at least one drop areas enable scripts to control the viewing of video; and
executing a script in response to a camera icon being dragged into a drop area.

2. The method according to claim 1, wherein the executing a script is in response to a camera icon being dragged and dropped on a drop area.

3. The method according to claim 1, wherein each of the at least one drop area is a semi-transparent icon that contains graphics and/or text to indicate the drop area's corresponding script or scripts, and wherein the at least one drop area is positioned over one or more of the tiles.

4. The method according to claim 1, wherein the executing a script comprises:
selecting a particular script, wherein the particular script depends on the camera icon dragged into the drop area.

5. The method according to claim 1, wherein the executing a script comprises:
spawning one or more new drop areas corresponding to configurable parameters for the script.

6. The method according to claim 5, wherein the configurable parameters include camera settings.

7. The method according to claim 5, wherein the configurable parameters include video playback settings.

8. The method according to claim 1, wherein the executing a script includes setting a direction in which the video is viewed.

9. The method according to claim 1, wherein the executing a script includes setting a video viewing speed.

10. The method according to claim 1, wherein the executing a script includes setting a start time and a stop time for viewing a snippet of a video recorded from a camera.

11. The method according to claim 1, wherein the drop areas and scripts are user configurable.

12. The method according to claim 1, wherein the drop areas and scripts are factory set and not user-configurable.

13. A video surveillance system comprising:
a network of video cameras;
a recorder communicatively coupled to the network of video cameras;
a computer communicatively coupled to the network of video cameras and the recorder, wherein the computer is configured to execute video management software (VMS), and wherein executing the VMS generates and renders a graphical user interface (GUI) on the computer's display, the GUI operable to:
display (i) camera icons that represent video cameras in the network of video cameras, (ii) tiles for displaying video, and (iii) at least one drop areas positioned on a tile, the at least one drop areas enabling scripts to control the viewing of video; and
execute a particular script in response to signals from the computer's input device, the signals corresponding to a particular camera icon being dragged into a particular drop area.

14. The video surveillance system according to claim 13, wherein the particular script is executed in response to a particular camera icon being (i) dragged into a particular drop area and (ii) dropped onto a the particular drop area.

15. The video surveillance system according to claim 13, wherein the particular script spawns one or more new drop areas in response to the particular camera icon being dragged into the particular drop area.

16. The video surveillance system according to claim 13, wherein the particular script controls how a video is played in a tile.

17. The video surveillance system according to claim 13, wherein the particular script controls a video camera in the video surveillance system.

18. The video surveillance system according to claim 17, wherein the video camera in the video surveillance system is a pan-tile-zoom (PZT) camera.

19. The video surveillance system according to claim 13, wherein the particular script controls the recorder.

20. A computer readable medium containing computer readable instructions that when executed by a processor of a computer cause the computer to perform a method comprising:
providing a graphical user interface (GUI) that includes:
camera icons representing cameras in the video surveillance system, wherein the camera icons support drag-and-drop interactions,
tiles for displaying video from a camera, and
at least one drop-area positioned on a tile, wherein the at least one drop areas enable scripts to control the viewing of a video; and
executing a script in response to a camera icon being dragged into a drop area.
